(19) United States
(12) Patent Application Publication
(10) Pub. No.: US 2017/0124086 A1
(43) Pub. Date: May 4, 2017

(54) RANKING OBJECTS BASED ON AFFINITY

(71) Applicant: LinkedIn Corporation, Mountain View, CA (US)

(72) Inventors: Yi Feng, Sunnyvale, CA (US); Weizhen Wang, San Jose, CA (US); Mudit Goel, Sunnyvale, CA (US); Dong Li, Sunnyvale, CA (US)

(21) Appl. No.: 14/939,937

(22) Filed: Nov. 12, 2015

Related U.S. Application Data
(60) Provisional application No. 62/249,135, filed on Oct. 30, 2015.

(51) Int. Cl. G06F 17/30; G06Q 50/00; G06Q 50/20; G06Q 10/10

(52) U.S. Cl. CPC G06F 17/3053; G06F 17/30598; G06F 17/30864; G06Q 10/105; G06Q 50/01; G06Q 50/2053

(57) ABSTRACT

In some embodiments, a method comprises: for each one of a plurality of first category objects, calculating a corresponding affinity value for the corresponding one of the plurality of first category objects with respect to a second category object based on the corresponding number of persons associated with both the corresponding one of the plurality of first category objects and the second category object from a plurality of second category objects, the number of persons associated with the second category object, the corresponding number of second category objects that are associated with a person that is associated with the corresponding one of the plurality of first category objects, and the number of second category objects in the plurality of second category objects; ranking the first category objects based on their corresponding affinity values; and performing a function of an online service based on the ranking of the first category objects.

### CROSS-REFERENCE TO RELATED APPLICATIONS

This application claims the benefit of priority, under 35 U.S.C. Section 119(e), to U.S. Provisional Application No. 62/249,135, filed on Oct. 30, 2015, entitled, “RANKING OBJECTS BASED ON AFFINITY”, which is hereby incorporated by reference in its entirety as if set forth herein.

### TECHNICAL FIELD

The present application relates generally to data processing systems and, in one specific example, to methods and systems of ranking objects based on affinity.

### BACKGROUND

Current online services are limited in their ability to determine and evaluate the correlation between two objects, such as the relevancy of a school to a company.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram illustrating a client-server system, in accordance with an example embodiment;

FIG. 2 is a block diagram showing the functional components of a social networking service within a networked system, in accordance with an example embodiment;

FIG. 3 is a block diagram illustrating components of an object affinity system, in accordance with an example embodiment;

FIGS. 4A-4B illustrate a graphical user interface (GUI) displaying a search page employing the object affinity system, in accordance with an example embodiment;

FIGS. 5A-5B illustrate a GUI displaying another search page employing the object affinity system, in accordance with an example embodiment;

FIG. 6 illustrates a GUI displaying a notification generated using the object affinity system, in accordance with an example embodiment;

FIG. 7 is a flowchart illustrating a method of ranking objects, in accordance with an example embodiment;

FIG. 8 is a flowchart illustrating a method of performing a function of an online service, in accordance with an example embodiment;

FIG. 9 is a block diagram illustrating a mobile device, in accordance with some example embodiments; and

FIG. 10 is a block diagram of an example computer system on which methodologies described herein may be executed, in accordance with an example embodiment.

### DETAILED DESCRIPTION

Example methods and systems of ranking object based on affinity are disclosed. In the following description, for purposes of explanation, numerous specific details are set forth in order to provide a thorough understanding of example embodiments. It will be evident, however, to one skilled in the art that the present embodiments may be practiced without these specific details.

The present disclosure introduces techniques of ranking object based on their corresponding affinity values. In some example embodiments, operations are performed by at least one processor, with the operations comprising: for each one of a plurality of first category objects, determining a corresponding number of persons associated with both the corresponding one of the plurality of first category objects and a second category object from a plurality of second category objects; determining a number of persons associated with the second category object; for each one of the plurality of first category objects, determining a corresponding number of second category objects that are associated with a person that is associated with the corresponding one of the plurality of first category objects; determining a number of second category objects in the plurality of second category objects; for each one of the plurality of the first category objects, calculating a corresponding affinity value for the corresponding one of the plurality of first category objects with respect to the second category object based on the corresponding number of persons associated with both the corresponding one of the plurality of first category objects and the second category object, the number of persons associated with the second category object, the corresponding number of second category objects that are associated with a person that is associated with the corresponding one of the plurality of first category objects, and the number of second category objects in the plurality of second category objects; ranking the plurality of first category objects based on their corresponding affinity values; and performing a function of an online service based on the ranking of the plurality of first category objects.

In some example embodiments, calculating the corresponding affinity value comprises calculating the corresponding number of persons associated with both the corresponding one of the plurality of first category objects and a second category object from a plurality of second category objects divided by the number of persons associated with the second category object. In some example embodiments, calculating the corresponding affinity value further comprises calculating the corresponding number of second category objects that are associated with a person that is associated with the corresponding one of the plurality of first category objects divided by the number of second category objects in the plurality of second category objects.

In some example embodiments, the plurality of first category objects comprises one plurality of category objects from a group of category objects consisting of a plurality of schools, a plurality of companies, a plurality of educational majors, and a plurality of job positions, and the plurality of second category objects comprises another plurality of category objects from the group of category objects, the plurality of second category objects being different from the plurality of first category objects.

In some example embodiments, the first plurality of category objects comprises a plurality of schools, the second plurality of category objects comprises a plurality of companies, the corresponding number of persons associated with both the corresponding one of the plurality of first category objects and the second category object from the plurality of second category objects comprises a corresponding number of employees at the corresponding one of the plurality of companies that graduated from the corresponding one of the plurality of schools, the number of persons associated with the second category object comprises a number of employees of the corresponding one of the plurality of companies, the corresponding number of second category objects that are associated with the person that is associated with the corresponding one of the plurality of first category objects comprises a number of the plurality of companies that have employees that graduated from the corresponding one of the plurality of schools, the number of second category objects in the plurality of second category objects comprises a number of the plurality of companies, and each one of the affinity values represents a level of affinity between the corresponding one of the plurality of companies and the corresponding one of the plurality of schools. In some example embodiments, the number of the plurality of companies that have employees that graduated from the corresponding one of the plurality of schools is restricted to ones of the plurality of companies that have at least one employee whose first job after graduating from the corresponding one of the plurality of schools was at the one of the plurality of companies.

In some example embodiments, the function of the online service comprises determining a presentation of at least a portion of the plurality of first category objects based on the ranking, and causing the presentation of the at least the portion of the plurality of first category objects to be displayed on the computing device. In some example embodiments, the presentation of the at least the portion of the plurality of first category objects comprises a visualization of at least a portion of the ranking of the plurality of first category objects.

In some example embodiments, the online service comprises a social networking service.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

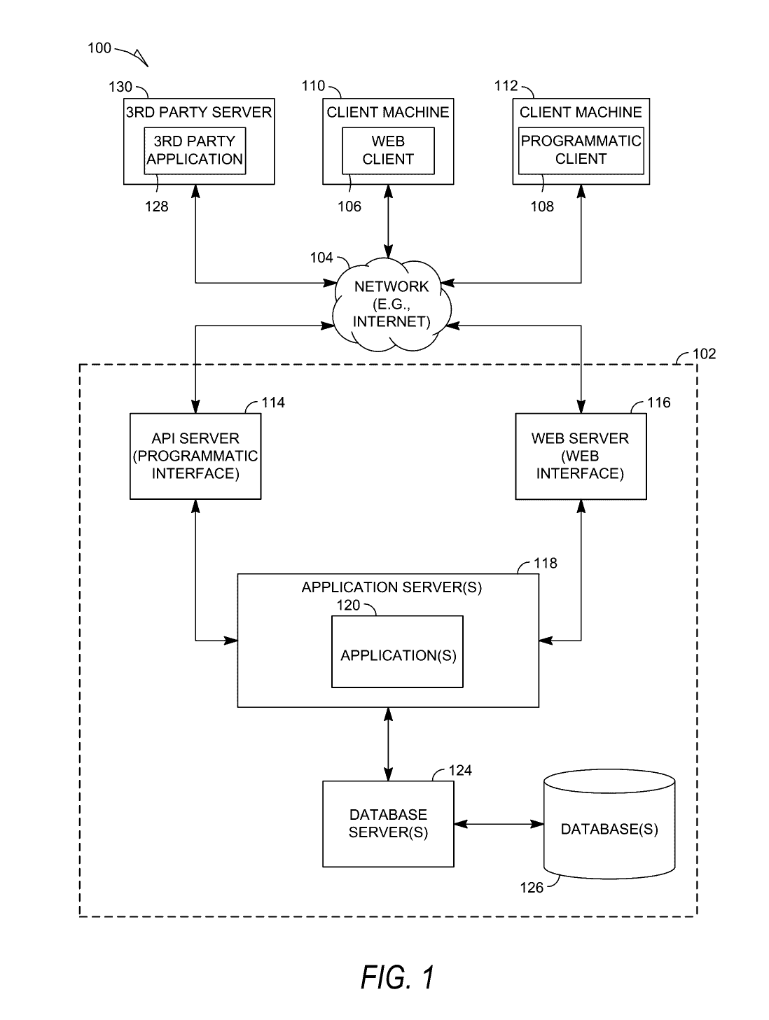

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

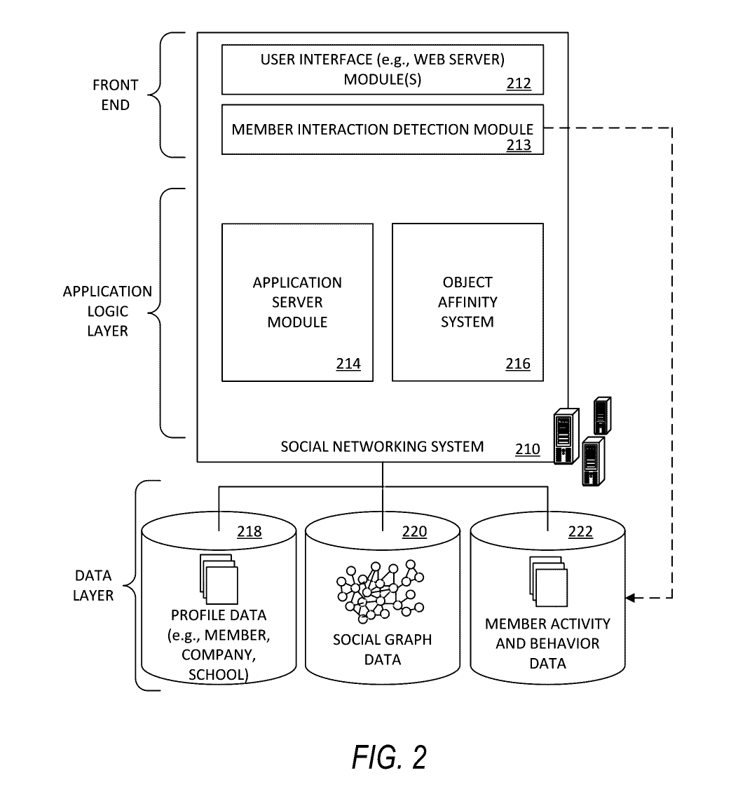

In some embodiments, the networked system 102 may comprise functional components of a social networking service. FIG. 2 is a block diagram showing the functional components of a social networking service 210, including a data processing module referred to herein as an object affinity system 216, for use in social networking system 210, consistent with some embodiments of the present disclosure. In some embodiments, the object affinity system 216 resides on application server 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the object affinity system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with reference number 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database with reference number 222. This logged activity information may then be used by the object affinity system 216.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the object affinity system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

In some example embodiments, an online service, such as a social networking service, provides services to members or other users. These services can include one or more services that provide insight regarding the correlation or relevancy between two different objects. In some example embodiments, an object is anything that has a value and can be referenced by an identifier. Examples of an object include, but are not limited to, a school, a company, an education major, and a job position or title. Different pluralities of objects can have different corresponding categories. In one example, each one of a plurality of schools is a category object of a category for schools. In this example, the category objects for the schools category could include universities, such as Stanford, UC Berkeley, UCLA, MIT, Harvard, Princeton, and the like. In some example embodiments, the object affinity system 216 is configured to determine, use, and provide information regarding the correlation or relationship between two or more category objects. For example, the object affinity system 216 can determine the top schools that a specific company hires employees from or the top companies that a specific company hires employees from. The object affinity system 216 can display this information and/or can use this information in determining objects (e.g., schools, companies, educational majors, job titles or positions) to recommend to users. In some example embodiments, the object affinity system 216 can rank a plurality of objects with respect to another object simply by using the corresponding number of associations between each one of the plurality of objects and the other object. Such associations can be determined based on a first category object and a second category object being associated with a common person. For example, the object affinity system 216 can rank schools based on the corresponding number of persons for each school who have joined a specific company directly after graduation from the corresponding school (e.g., where the specific company provide the first job after graduation for a person). In another example, the object affinity system 216 can rank companies based on the corresponding number of persons for each company that transitioned directly from the corresponding company to a specific company. This association information can be determined based on user profiles on one or more social networking services, such as via stored education history and employment history.

Despite the benefits of the above-described approach, the downside is that it only considers one-side, such as the number of appearance of one company or school with respect to another, in other words, the frequency of a company or school to another company or school. There are several useful insights missing in this determination, evaluation, and ranking methodology.

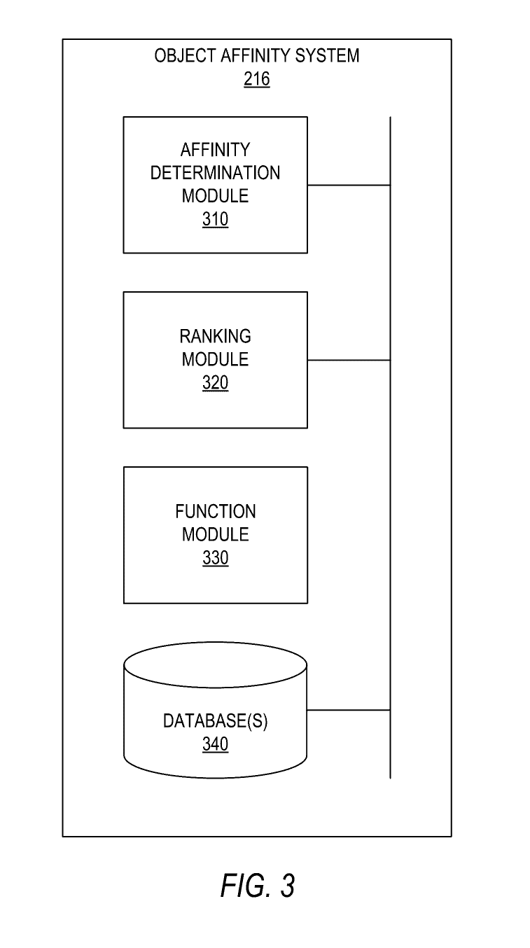

FIG. 3 is a block diagram illustrating components of the object affinity system 216, in accordance with an example embodiment. In some embodiments, the object affinity system 216 comprises any combination of one or more of an affinity determination module 310, a ranking module 320, a function module 330, and one or more database(s) 340. The affinity determination module 310, the ranking module 320, and the function module 330 can reside on a machine having a memory and at least one processor (not shown). In some embodiments, these modules 310, 320, and 330 can be incorporated into the application server(s) 118 in FIG. 1. In some example embodiments, the database(s) 340 is incorporated into database(s) 126 in FIG. 1 or into any combination of one or more of databases 218, 220, and 222 in FIG. 2. However, it is contemplated that other configurations of the modules 310, 320, and 330, as well as the database(s) 340, are also within the scope of the present disclosure.

In some example embodiments, the affinity determination module 310 is configured to, for each one of a plurality of first category objects, determine a corresponding number of persons associated with both the corresponding one of the plurality of first category objects and a second category object from a plurality of second category objects. For example, for each one or a plurality of schools, the affinity determination module 310 can determine the number of employees at a specific company who graduated from the corresponding school.

In some example embodiments, the affinity determination module 310 is configured to determine a number of persons associated with the second category object. For example, the affinity determination module 310 can determine the number of employees at the specific company.

In some example embodiments, the affinity determination module 310 is configured to, for each one of the plurality of first category objects, determine a corresponding number of second category objects that are associated with a person that is associated with the corresponding one of the plurality of first category objects. For example, for each one of the plurality of schools, the affinity determination module 310 can determine the number of companies that the corresponding school has graduated students transitioning to.

In some example embodiments, the affinity determination module 310 is configured to determine a number of second category objects in the plurality of second category objects. For example, the affinity determination module 310 can determine the number of companies in the set of companies to which the specific company belongs.

In some example embodiments, the affinity determination module 310 is configured to, for each one of the plurality of the first category objects, calculate a corresponding affinity value for the corresponding one of the plurality of first category objects with respect to the second category object based on the corresponding number of persons associated with both the corresponding one of the plurality of first category objects and the second category object, the number of persons associated with the second category object, the corresponding number of second category objects that are associated with a person that is associated with the corresponding one of the plurality of first category objects, and the number of second category objects in the plurality of second category objects.

In some example embodiments, the affinity determination module 310 is configured to calculate the corresponding affinity value by, in part, calculating the corresponding number of persons associated with both the corresponding one of the plurality of first category objects and a second category object from a plurality of second category objects divided by the number of persons associated with the second category object. In some example embodiments, the affinity determination module 310 is configured to calculate the corresponding affinity value by, in part, calculating the corresponding number of second category objects that are associated with a person that is associated with the corresponding one of the plurality of first category objects divided by the number of second category objects in the plurality of second category objects.

An example of calculating school-company affinity values is provides below. In this example, let S be the entire school set and C be the entire company set being managed by or available as objects to an online service. T represents all transitions from S to C. In some example embodiments, we consider a transition between s and c T(s, c) is valid only when a member joined a company c right after graduating from school s. TC(s) is the set of companies that school s has graduated students transitioning to. G(s) is the set of all graduated students of school s. E(c) is the set of all employees of company c. H(s, c) is the set of employees at company c who graduated from school s.

Given the above definitions, Term Frequency (tf) can be determined as follows:

$$tf ( s , c ) = \frac{\vert H ( s , c ) \vert}{E ( c )}$$

and Inverse Document Frequency (idf, inverse frequency smooth) can be determined as follows:

$$idf ( s , C ) = log ( 1 + \frac{\vert TC ( s ) \vert}{\vert C \vert} ) .$$

So, in some example embodiments, the affinity value aff (s, c, C) of a given school s and company c is:

$$tfidf ( s , c , C ) = aff ( s , c , C ) = tf ( s , c ) \times idf ( s , C ) = \frac{\vert H ( s , c ) \vert}{E ( c )} \times log ( 1 + \frac{\vert TC ( s ) \vert}{\vert C \vert} ) .$$

A concrete example is provided below (to simplify the demo calculation, we do not use logarithm):
S={S1, S2}
C={C1, C2, C3}
G(S1)=100
G(S2)=500
TC(S1)={C1, C2}
TC(S2)={C1, C2, C3}
H(S1, C1)=50
H(S1, C2)=50
H(S2, C1)=60
H(S2, C2)=100
H(S2, C3)=340
E(C1)=H(S1, C1)+H(S2, C2)=110
E(C2)=H(S1, C2)+H(S2, C2)=150
E(C3)=H(S2, C3)=340

aff(S1,C1,C)=H(S1,C1)/E(C1)*|C|/|TC(S1)|=50/110*3/2=15/22

aff(S2,C1,C)=H(S2,C1)/E(C1)*|C|/|TC(S2)|=60/110*3/3=12/22

If just comparing the numbers of employees graduated from different schools (e.g., S1 and S2) and currently working at company C1, we would see that school S2, with 60 graduates working at C1, is ranked higher than school S1, with only 50 graduates working at C1. However, using the affinity value, we get S1 being higher than S2, which tells us that students from S1 are much closer (e.g., more strongly correlated) to company C1 than students from S2, or in other words, S1's students are more popular or relevant to company C1 than S2.

Affinity values can also be calculated for the schools S1 and S2 with respect to C2:

aff(S1,C2,C)=H(S1,C2)/E(C2)*|C|/|TC(S1)|=50/150*3/2=1/2

aff(S2,C2,C)=H(S2,C2)/E(C2)*|C|/|TC(S2)|=100/150*3/3=2/3

In this case, the absolute number of employees in company C2 graduated from S2 is twice the number of S1, while the difference between the affinity values is much less.

Affinity values can also be calculated for the schools S1 and S2 with respect to C2:

aff(S1,C3,C)=0

aff(S2,C3,C)=H(S2,C3)/E(C3)*|C|/|TC(S2)|=340/340*3/3=1

Affinity values can also be used to measure the closeness between companies with respect to a given school. In the example above, for S1, C1 is closer than C2 because they hire the same amount of graduates from S1, but C1 has a higher percentage. For S2, company C3 has the highest affinity value among all three companies because it only hires from S2.

In some example embodiments, the affinity determination module 310 is configured to store the determined values discussed above in the one or more databases 340 for subsequent access and retrieval by the object affinity system 216.

In some example embodiments, the ranking module 310 is configured to rank the plurality of first category objects based on their corresponding affinity values. For example, the ranking module 310 can rank the first category objects in order of their corresponding affinity values from highest to lowest.

In some example embodiments, the function module 330 is configured to perform a function of an online service based on one or more of the corresponding affinity values of the plurality of first category objects or on the ranking of the plurality of first category objects. For example, the function module 330 can display a portion of the plurality of first category objects based on the ranking (e.g., the top six schools with the highest affinity values). In another example, the function module 33 can display a portion of the plurality of first category objects bases on their corresponding affinity values (e.g., only schools having a corresponding affinity value that meets or exceeds a predetermined threshold).

In some example embodiments, the function of the online service comprises determining a presentation of at least a portion of the plurality of first category objects based on one or more of the corresponding affinity values or the ranking, and causing the presentation of the at least the portion of the plurality of first category objects to be displayed on a computing device. In some example embodiments, the presentation of the at least the portion of the plurality of first category objects comprises a visualization of at least a portion of the corresponding affinity values or the ranking of the plurality of first category objects. The presentation can be displayed to a user in a variety of different contexts, including, but not limited to, an active search context, a discovery context, and a notification context.

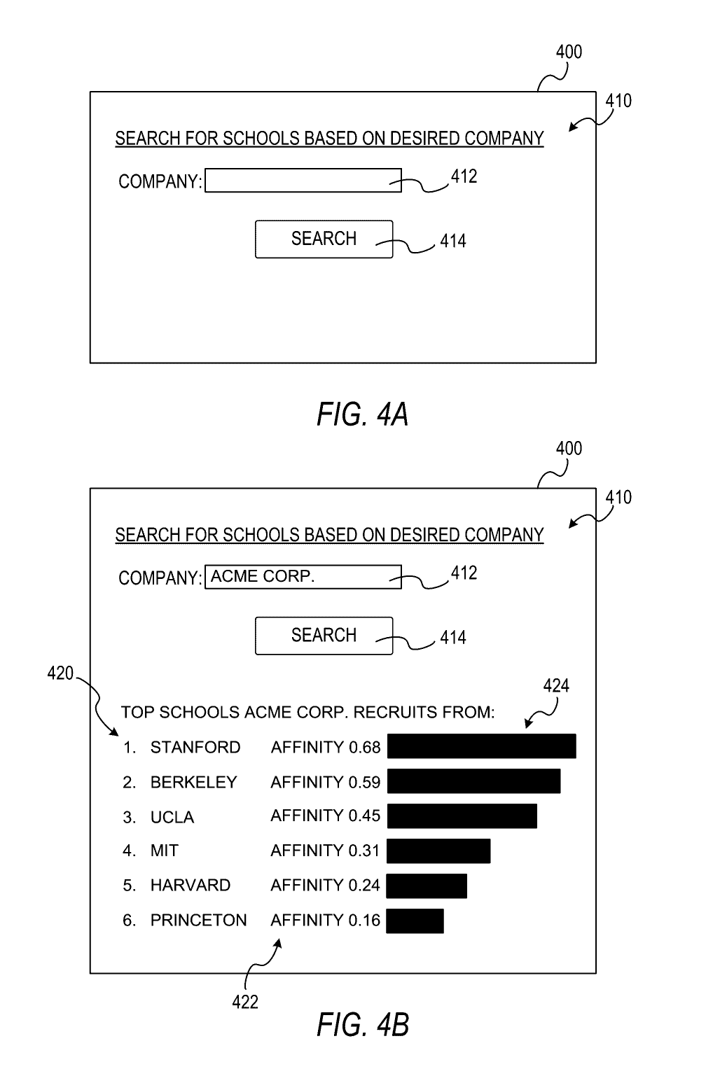

FIGS. 4A-4B illustrate a graphical user interface (GUI) 400 displaying a search page 410 employing the object affinity system 216, in accordance with an example embodiment. In FIG. 4A, the search page 410 enables a user to search for schools that are most relevant to a specified company (e.g., the schools that the specified company is most likely to hire from). In some example, embodiments, the search page 410 comprises a GUI element 412 (e.g., a text field) by which the user can specify the specified company. The search page 410 can also include a selectable GUI element 414 configured to submit the user's input for GUI element 412 in response to being selected.

In FIG. 4B, the user has submitted a search request with “ACME CORP.” provided as the specified company. Search results can be displayed in the form of a ranking of schools, such as top six schools in terms of affinity values with respect to the specified company. The corresponding affinity values 422 and a graphical representation or visualization 424 of the corresponding affinity values 422 can also be displayed.

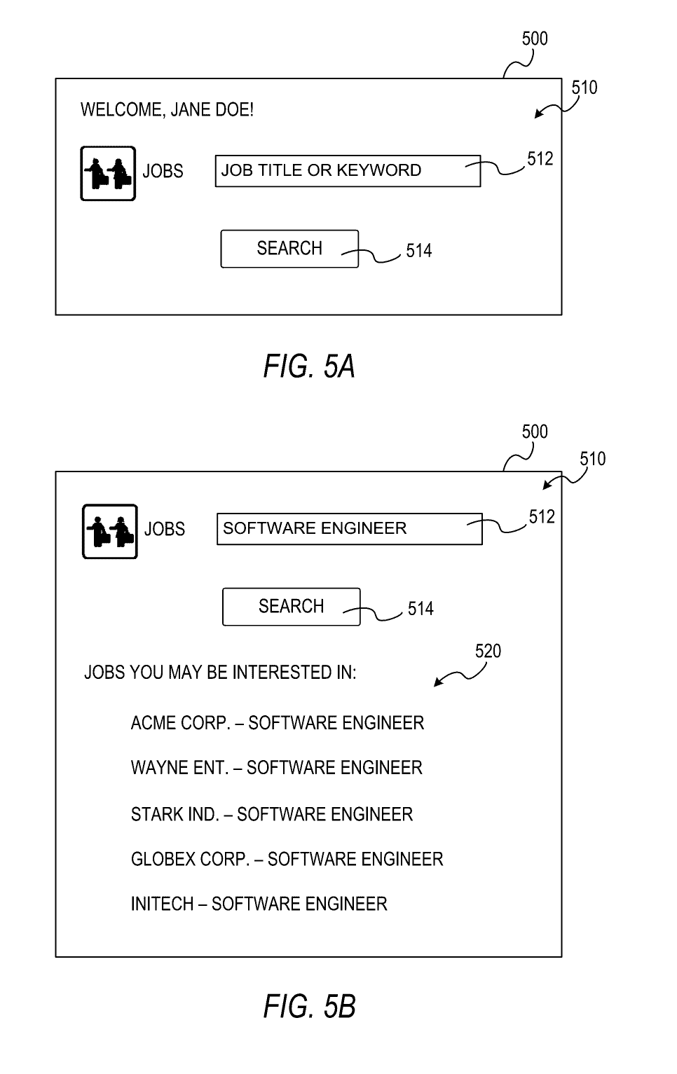

FIGS. 5A-5B illustrate a GUI 500 displaying another search page 510 employing the object affinity system 216, in accordance with an example embodiment. In FIG. 5A, the search page 510 enables a user to search for job openings at companies that are most relevant to a specified job title or position (e.g., the schools that the specified company is most likely to hire from). In some example, embodiments, the search page 510 comprises a GUI element 512 (e.g., a text field) by which the user can specify a job title/position or a keyword. The search page 510 can also include a selectable GUI element 514 configured to submit the user's input for GUI element 512 in response to being selected.

In FIG. 5B, the user has submitted a search request with “SOFTWARE ENGINEER” provided as the job title/position or keyword. Search results 520 can be displayed in the form of an identification companies having an opening for the specified job title/position. The search results 520 can comprise selectable links that are configured to cause the display of additional details of the job opening at the corresponding company in response to selection of the corresponding selectable link. These search results 520 can be determined by the function module 330 based on the affinity values or ranking of the affinity values. For example, out of the pool of companies having a job opening that matches the user's specified job title/position, the function module 330 can select the top five companies in terms of affinity values with respect to the user's profile information, such as the user's school, the user's educational major, and the user's current employer company. The user can be identified based on login information or an IP address associated with the user, and the user's profile information can then be determined. The search results can be determined based on which companies have the highest affinity values with respect to the user's profile information.

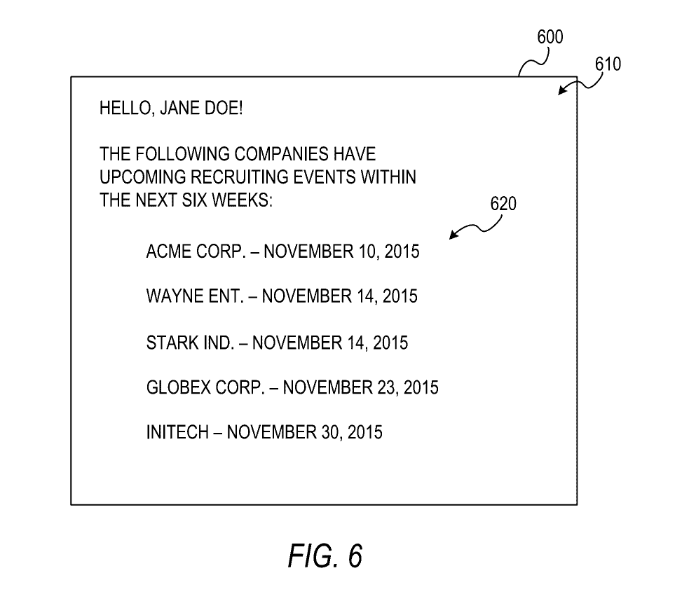

FIG. 6 illustrates a GUI 600 displaying a notification 610 generated using the object affinity system 216, in accordance with an example embodiment. In some example embodiments, the notification 610 is presented to a user via an e-mail message, text message, a page of a mobile application of an online service, or a web page of an online service. In some example embodiments, the function module 330 determines content items 620 to include within the notification 610 based on the corresponding affinity values of the corresponding category content objects (e.g., company) of the content items 620. In the example shown in FIG. 6, the function module 330 can provide the notification 610 as an e-mail message listing upcoming recruiting events for a certain portion of companies (e.g., the five companies with the highest affinity values with respect to the user's school).

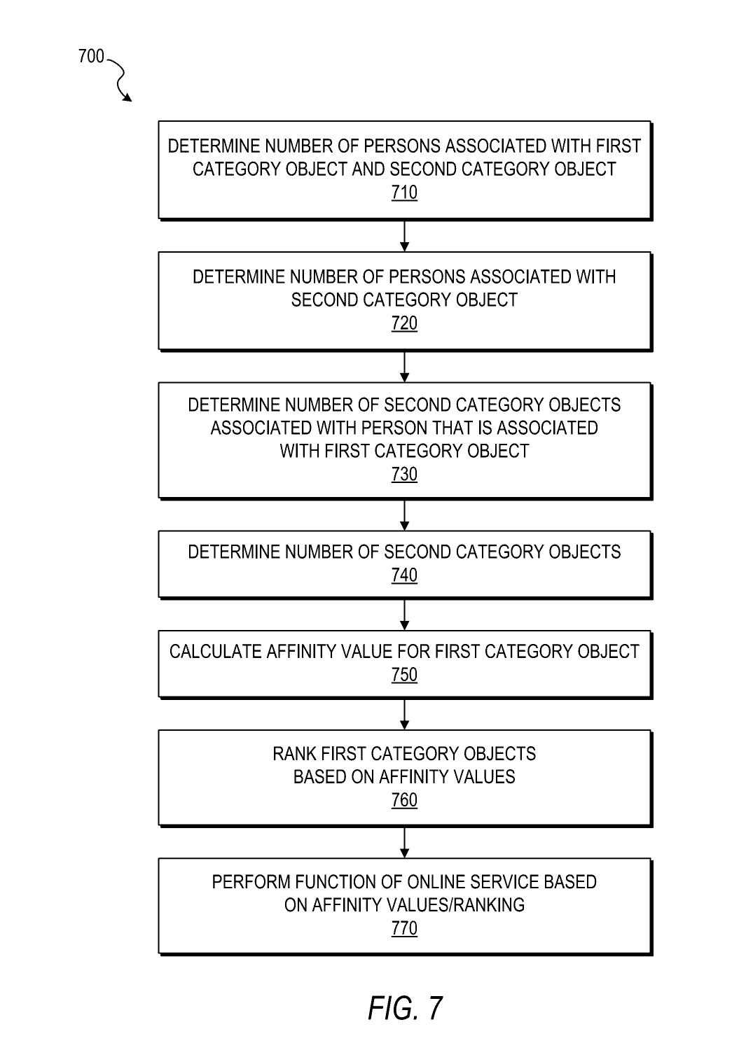

FIG. 7 is a flowchart illustrating a method of ranking objects, in accordance with an example embodiment. Method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the object affinity system 216 of FIGS. 2-3, or any combination of one or more of its modules, as described above.

At operation 710, for each one of a plurality of first category objects, the affinity determination module 310 determines a corresponding number of persons associated with both the corresponding one of the plurality of first category objects and a second category object from a plurality of second category objects. At operation 720, the affinity determination module 310 determines a number of persons associated with the second category object. At operation 730, for each one of the plurality of first category objects, the affinity determination module 310 determines a corresponding number of second category objects that are associated with a person that is associated with the corresponding one of the plurality of first category objects. At operation 740, the affinity determination module 310 determines a number of second category objects in the plurality of second category objects.

In some example embodiments, the plurality of first category objects comprises one plurality of category objects from a group of category objects consisting of a plurality of schools, a plurality of companies, a plurality of educational majors, and a plurality of job positions, and the plurality of second category objects comprises another plurality of category objects from the group of category objects, the plurality of second category objects being different from the plurality of first category objects.

At operation 750, for each one of the plurality of the first category objects, the affinity determination module 310 calculates a corresponding affinity value for the corresponding one of the plurality of first category objects with respect to the second category object based on the corresponding number of persons associated with both the corresponding one of the plurality of first category objects and the second category object, the number of persons associated with the second category object, the corresponding number of second category objects that are associated with a person that is associated with the corresponding one of the plurality of first category objects, and the number of second category objects in the plurality of second category objects.

In some example embodiments, calculating the corresponding affinity value comprises calculating the corresponding number of persons associated with both the corresponding one of the plurality of first category objects and a second category object from a plurality of second category objects divided by the number of persons associated with the second category object. In some example embodiments, calculating the corresponding affinity value further comprises calculating the corresponding number of second category objects that are associated with a person that is associated with the corresponding one of the plurality of first category objects divided by the number of second category objects in the plurality of second category objects.

At operation 760, the ranking module 320 ranks the plurality of first category objects based on their corresponding affinity values. At operation 770, the function module 330 performs a function of an online service based on the ranking of the plurality of first category objects.

It is contemplated that any of the other features described within the present disclosure can be incorporated into method 700.

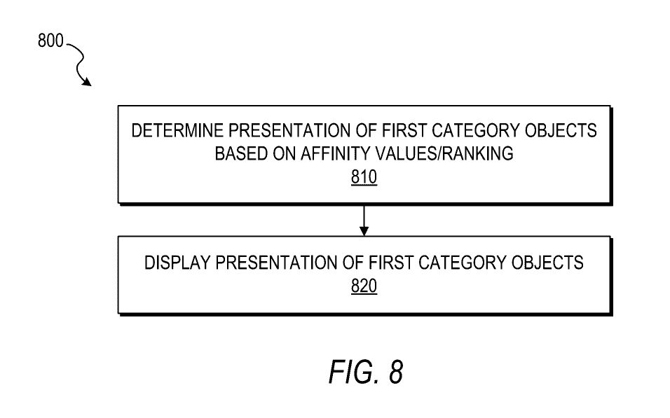

FIG. 8 is a flowchart illustrating a method 800 of performing a function of an online service, in accordance with an example embodiment. Method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the object affinity system 216 of FIGS. 2-3, or any combination of one or more of its modules, as described above.

At operation 810, the function module 330 determines a presentation of at least a portion of the plurality of first category objects based on the ranking At operation 820, the function module 330 causes the presentation of the at least the portion of the plurality of first category objects to be displayed on the computing device. In some example embodiments, the presentation of the at least the portion of the plurality of first category objects comprises a visualization of at least a portion of the ranking of the plurality of first category objects.

It is contemplated that any of the other features described within the present disclosure can be incorporated into method 800.

### Example Mobile Device

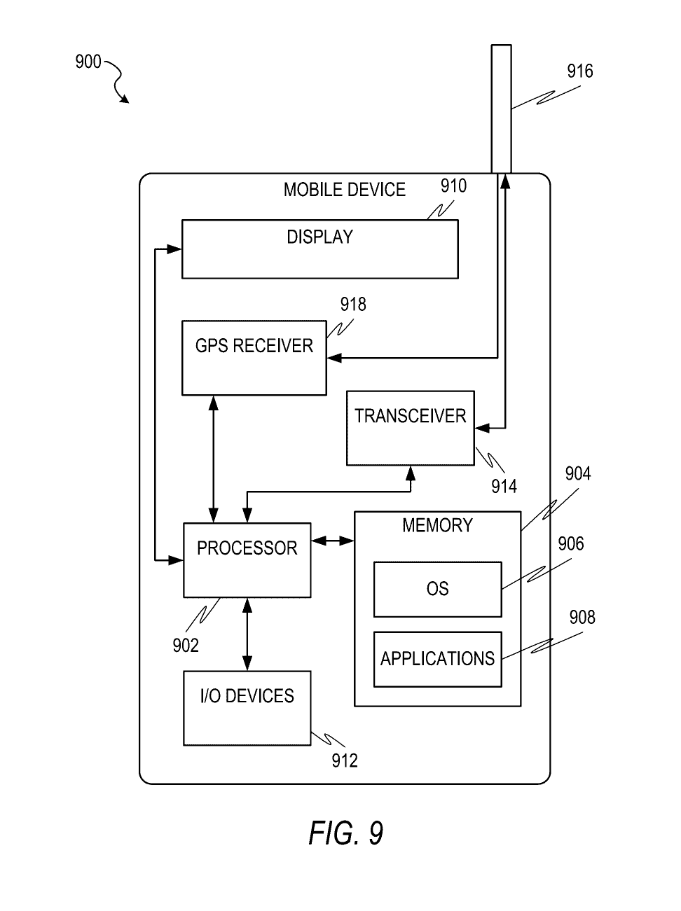

FIG. 9 is a block diagram illustrating a mobile device 900, according to an example embodiment. The mobile device 900 can include a processor 902. The processor 902 can be any of a variety of different types of commercially available processors suitable for mobile devices 900 (for example, an XScale architecture microprocessor, a Microprocessor without Interlocked Pipeline Stages (MIPS) architecture processor, or another type of processor). A memory 904, such as a random access memory (RAM), a Flash memory, or other type of memory, is typically accessible to the processor 902. The memory 904 can be adapted to store an operating system (OS) 906, as well as application programs 908, such as a mobile location enabled application that can provide location-based services (LBSs) to a user. The processor 902 can be coupled, either directly or via appropriate intermediary hardware, to a display 910 and to one or more input/output (I/O) devices 912, such as a keypad, a touch panel sensor, a microphone, and the like. Similarly, in some embodiments, the processor 902 can be coupled to a transceiver 914 that interfaces with an antenna 916. The transceiver 914 can be configured to both transmit and receive cellular network signals, wireless data signals, or other types of signals via the antenna 916, depending on the nature of the mobile device 900. Further, in some configurations, a GPS receiver 918 can also make use of the antenna 916 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

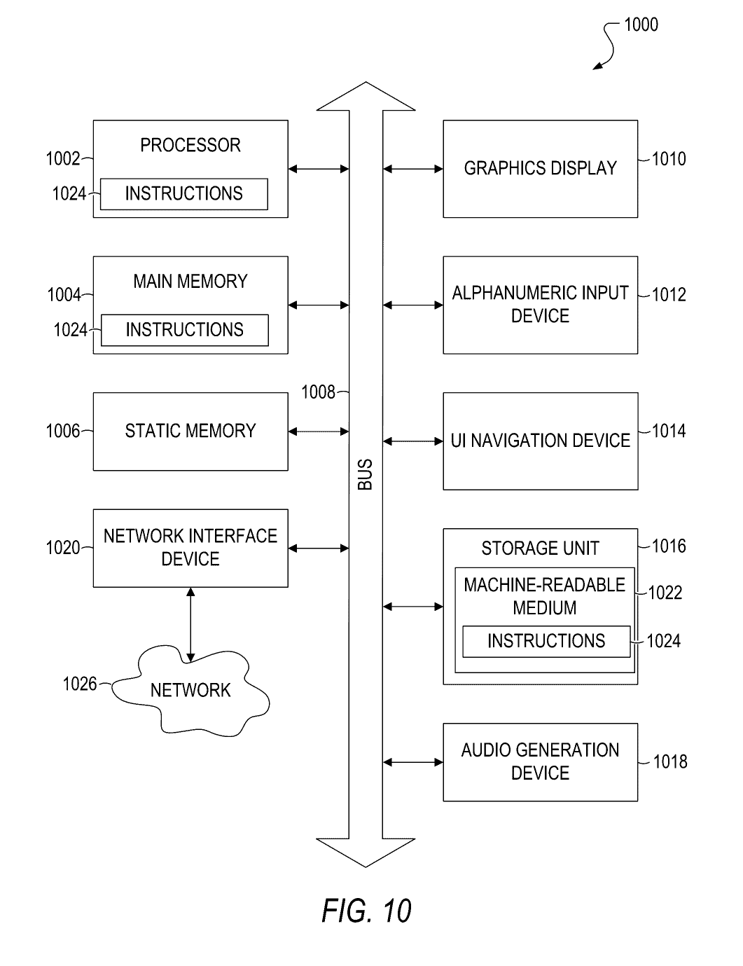

FIG. 10 is a block diagram of an example computer system 1000 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
for each one of a plurality of first category objects, determining a corresponding number of persons associated with both the corresponding one of the plurality of first category objects and a second category object from a plurality of second category objects;
determining a number of persons associated with the second category object;
for each one of the plurality of first category objects, determining a corresponding number of second category objects that are associated with a person that is associated with the corresponding one of the plurality of first category objects;
determining a number of second category objects in the plurality of second category objects;
for each one of the plurality of the first category objects, calculating, by at least one processor, a corresponding affinity value for the corresponding one of the plurality of first category objects with respect to the second category object based on the corresponding number of persons associated with both the corresponding one of the plurality of first category objects and the second category object, the number of persons associated with the second category object, the corresponding number of second category objects that are associated with a person that is associated with the corresponding one of the plurality of first category objects, and the number of second category objects in the plurality of second category objects;
ranking the plurality of first category objects based on their corresponding affinity values; and
performing a function of an online service based on the ranking of the plurality of first category objects.

2. The computer-implemented method of claim 1, wherein calculating the corresponding affinity value comprises calculating the corresponding number of persons associated with both the corresponding one of the plurality of first category objects and a second category object from a plurality of second category objects divided by the number of persons associated with the second category object.

3. The computer-implemented method of claim 2, wherein calculating the corresponding affinity value further comprises calculating the corresponding number of second category objects that are associated with a person that is associated with the corresponding one of the plurality of first category objects divided by the number of second category objects in the plurality of second category objects.

4. The computer-implemented method of claim 1, wherein:
the plurality of first category objects comprises one plurality of category objects from a group of category objects consisting of a plurality of schools, a plurality of companies, a plurality of educational majors, and a plurality of job positions; and
the plurality of second category objects comprises another plurality of category objects from the group of category objects, the plurality of second category objects being different from the plurality of first category objects.

5. The computer-implemented method of claim 1, wherein:
the first plurality of category objects comprises a plurality of schools;
the second plurality of category objects comprises a plurality of companies;
the corresponding number of persons associated with both the corresponding one of the plurality of first category objects and the second category object from the plurality of second category objects comprises a corresponding number of employees at the corresponding one of the plurality of companies that graduated from the corresponding one of the plurality of schools;
the number of persons associated with the second category object comprises a number of employees of the corresponding one of the plurality of companies;
the corresponding number of second category objects that are associated with the person that is associated with the corresponding one of the plurality of first category objects comprises a number of the plurality of companies that have employees that graduated from the corresponding one of the plurality of schools;
the number of second category objects in the plurality of second category objects comprises a number of the plurality of companies; and
each one of the affinity values represents a level of affinity between the corresponding one of the plurality of companies and the corresponding one of the plurality of schools.

6. The computer-implemented method of claim 5, wherein the number of the plurality of companies that have employees that graduated from the corresponding one of the plurality of schools is restricted to ones of the plurality of companies that have at least one employee whose first job after graduating from the corresponding one of the plurality of schools was at the one of the plurality of companies.

7. The computer-implemented method of claim 1, wherein the function of the online service comprises:
determining a presentation of at least a portion of the plurality of first category objects based on the ranking; and
causing the presentation of the at least the portion of the plurality of first category objects to be displayed on the computing device.

8. The computer-implemented method of claim 7, wherein the presentation of the at least the portion of the plurality of first category objects comprises a visualization of at least a portion of the ranking of the plurality of first category objects.

9. The computer-implemented method of claim 1, wherein the online service comprises a social networking service.

10. A system comprising:
at least one processor; and
a non-transitory machine-readable medium embodying a set of instructions that, when executed by the at least one processor, cause the at least one processor to perform operations, the operations comprising:
for each one of a plurality of first category objects, determining a corresponding number of persons associated with both the corresponding one of the plurality of first category objects and a second category object from a plurality of second category objects;
determining a number of persons associated with the second category object;
for each one of the plurality of first category objects, determining a corresponding number of second category objects that are associated with a person that is associated with the corresponding one of the plurality of first category objects;
determining a number of second category objects in the plurality of second category objects;
for each one of the plurality of the first category objects, calculating a corresponding affinity value for the corresponding one of the plurality of first category objects with respect to the second category object based on the corresponding number of persons associated with both the corresponding one of the plurality of first category objects and the second category object, the number of persons associated with the second category object, the corresponding number of second category objects that are associated with a person that is associated with the corresponding one of the plurality of first category objects, and the number of second category objects in the plurality of second category objects;
ranking the plurality of first category objects based on their corresponding affinity values; and
performing a function of an online service based on the ranking of the plurality of first category objects.

11. The system of claim 10, wherein calculating the corresponding affinity value comprises calculating the corresponding number of persons associated with both the corresponding one of the plurality of first category objects and a second category object from a plurality of second category objects divided by the number of persons associated with the second category object.

12. The system of claim 11, wherein calculating the corresponding affinity value further comprises calculating the corresponding number of second category objects that are associated with a person that is associated with the corresponding one of the plurality of first category objects divided by the number of second category objects in the plurality of second category objects.

13. The system of claim 10, wherein:
the plurality of first category objects comprises one plurality of category objects from a group of category objects consisting of a plurality of schools, a plurality of companies, a plurality of educational majors, and a plurality of job positions; and
the plurality of second category objects comprises another plurality of category objects from the group of category objects, the plurality of second category objects being different from the plurality of first category objects.

14. The system of claim 10, wherein:
the first plurality of category objects comprises a plurality of schools;
the second plurality of category objects comprises a plurality of companies;
the corresponding number of persons associated with both the corresponding one of the plurality of first category objects and the second category object from the plurality of second category objects comprises a corresponding number of employees at the corresponding one of the plurality of companies that graduated from the corresponding one of the plurality of schools;
the number of persons associated with the second category object comprises a number of employees of the corresponding one of the plurality of companies;
the corresponding number of second category objects that are associated with the person that is associated with the corresponding one of the plurality of first category objects comprises a number of the plurality of companies that have employees that graduated from the corresponding one of the plurality of schools;
the number of second category objects in the plurality of second category objects comprises a number of the plurality of companies; and
each one of the affinity values represents a level of affinity between the corresponding one of the plurality of companies and the corresponding one of the plurality of schools.

15. The system of claim 14, wherein the number of the plurality of companies that have employees that graduated from the corresponding one of the plurality of schools is restricted to ones of the plurality of companies that have at least one employee whose first job after graduating from the corresponding one of the plurality of schools was at the one of the plurality of companies.

16. The system of claim 10, wherein the function of the online service comprises:
determining a presentation of at least a portion of the plurality of first category objects based on the ranking; and
causing the presentation of the at least the portion of the plurality of first category objects to be displayed on the computing device.

17. The system of claim 16, wherein the presentation of the at least the portion of the plurality of first category objects comprises a visualization of at least a portion of the ranking of the plurality of first category objects.

18. The system of claim 10, wherein the online service comprises a social networking service.

19. A non-transitory machine-readable medium embodying a set of instructions that, when executed by a processor, cause the processor to perform operations, the operations comprising:
for each one of a plurality of first category objects, determining a corresponding number of persons associated with both the corresponding one of the plurality of first category objects and a second category object from a plurality of second category objects;
determining a number of persons associated with the second category object;
for each one of the plurality of first category objects, determining a corresponding number of second category objects that are associated with a person that is associated with the corresponding one of the plurality of first category objects;
determining a number of second category objects in the plurality of second category objects;
for each one of the plurality of the first category objects, calculating a corresponding affinity value for the corresponding one of the plurality of first category objects with respect to the second category object based on the corresponding number of persons associated with both the corresponding one of the plurality of first category objects and the second category object, the number of persons associated with the second category object, the corresponding number of second category objects that are associated with a person that is associated with the corresponding one of the plurality of first category objects, and the number of second category objects in the plurality of second category objects;
ranking the plurality of first category objects based on their corresponding affinity values; and
performing a function of an online service based on the ranking of the plurality of first category objects.

20. The method of claim 1, wherein calculating the corresponding affinity value comprises calculating the corresponding number of persons associated with both the corresponding one of the plurality of first category objects and a second category object from a plurality of second category objects divided by the number of persons associated with the second category object.
